(19) United States
(12) Patent Application Publication
(10) Pub. No.: US 2026/0104810 A1
(43) Pub. Date: Apr. 16, 2026

(54) SYSTEMS AND METHODS FOR ENHANCING POWER MODE TRANSITIONS IN UNIVERSAL FLASH STORAGE (UFS) DEVICES TO REDUCE POWER CONSUMPTION AND LATENCIES

(71) Applicant: QUALCOMM INCORPORATED, San Diego, CA (US)

(72) Inventors: Madhu Yashwanth BOENAPALLI, Hyderabad (IN); Sai Praneeth SREERAM, Anantapur (IN); Santhosh Reddy AKAVARAM, Hyderabad (IN); Surendra PARAVADA, Hyderabad (IN); Sang TRAN, Encinitas, CA (US); Hung VUONG, Coronado, CA (US)

(21) Appl. No.: 18/916,574

(22) Filed: Oct. 15, 2024

(51) Int. Cl. G06F 3/06

(52) U.S. Cl. CPC G06F 3/0625; G06F 3/0634; G06F 3/0659; G06F 3/0679

(57) ABSTRACT

Systems and methods are provided for enhancing Universal Flash storage (UFS) power mode transitions by autonomously entering the sleep or power down states upon the expiration of a timer, thereby eliminating the need to reactivate the link between the UFS host and the UFS device to send sleep or power down commands from the UFS host to the UFS device. Eliminating the need to frequently reactivate the link to transition it into sleep and power down states reduces power consumption associated with reactivating the link and keeping it in the active state while the sleep and power commands are transmitted by the UFS host and responded to by the UFS device. In addition, eliminating the need to frequently reactivate the link and keep it active for these purposes reduces latencies associated with issuing the sleep and power down commands.

### DESCRIPTION OF THE RELATED ART

A computing device may include multiple processor-based subsystems. Such a computing device may be, for example, a portable computing device (“PCD”), such as a laptop or palmtop computer, a cellular telephone or smartphone, a portable digital assistant, a portable game console, etc. Still other types of PCDs may be included in automotive and Internet-of-Things (“IoT”) applications. A computing device may also be a stationary computer, such as a personal computer (PC) or various types of desktop computers or workstation computers.

Such processor-based subsystems may be included within the same integrated circuit chip or in different chips. A “system-on-a-chip”, or “SoC”, is an example of one such chip that integrates numerous subsystems to provide system-level functionality. For example, an SoC may include one or more types of processors, such as central processing units (“CPU” ), graphics processing units (“GPU” ), digital signal processors (“DSP” ), and neural processing units (“NPU” ). An SoC may include other subsystems, such as a transceiver or “modem” subsystem that provides wireless connectivity, a memory subsystem, etc.

Computing devices also include various types of memory devices that are used by the processing units for storing data and computer instructions, including Universal Flash Storage (UFS) devices, for example. UFS devices are placed in different power modes to optimize power consumption, namely, active mode, idle mode, sleep mode, deep sleep mode and auto hibernate mode, often referred to as “AH8” mode. If there are no commands in the command queue of the UFS host to be sent to the UFS device, the UFS host does not need to communicate with the UFS device, and therefore the link between the UFS host and the UFS device is hibernated by placing it in AH8 mode. When the link is hibernated, the UFS device can be in active state or in idle state. To enter further low power modes (LPMs) such as the sleep or power down states, the link must be reactivated to allow the UFS host to send a start stop unit (SSU) power condition (PC) 2 command or a SSU PC 3 command to the UFS device to place it in the pre-sleep state or pre-power down state, respectively. The SSU PC 2 and 3 commands are standard UFS commands defined in the JDEC 220F standard.

After entering the pre-sleep or pre-power down states, the UFS device eventually enters the sleep or power down states, respectively. The reactivation of the link in this manner can occur thousands of times per day due to the frequent transitioning of the UFS device into different power modes. This frequent reactivation results in significant power consumption and increases latency in issuing the SSU PC 2 and 3 commands.

### SUMMARY OF THE DISCLOSURE

Systems, methods, and other examples are disclosed for enhancing power mode transitions in UFS devices to reduce power consumption and latencies.

An exemplary embodiment of the method comprises, with the UFS host, sending a command to the UFS device over a link that instructs the UFS device to generate a time value estimate. The method may further comprise, in the UFS device, in response to receiving the command, generating the time value estimate, sending the time value estimate over the link in a response to the UFS host. The method may further comprise, in the UFS host, in response to receiving the time value estimate in the UFS host, causing the link to be hibernated, setting a timer to the time value estimate and starting the timer. The method may further comprise, in response to an indication that the timer has expired, adjusting at least one supply voltage of the UFS device to a sleep mode level.

An exemplary embodiment of the system comprises a UFS host comprising a UFS controller, which comprises logic configured to send a command to a UFS device over a link that instructs the UFS device to generate a time value estimate. The system may further comprise logic configured to receive the time value estimate from the UFS device over the link. The system may further comprise logic configured to, in response to receiving the time value estimate in the host device, cause the link to be hibernated, set a timer to the time estimate value and start the timer. The system may further comprise logic configured to, in response to an indication that the timer has expired, adjust at least one supply voltage of the UFS device to sleep mode level to place the UFS device in sleep mode.

An exemplary embodiment of a computer program embodied on a non-transitory computer-readable medium. The computer program comprises computer instructions for execution by a processor. The computer instructions comprise first, second, third, fourth and fifth sets of computer instructions. The first set of computer instructions causes a command to be sent from the UFS host to the UFS device over a link that instructs the UFS device to generate a time value estimate. The second set of computer instructions receives the time value estimate from the UFS device over the link. A third set of computer instructions for, in response to receiving the time value estimate in the host device, causing the link to be hibernated, setting a timer to the time estimate value and starting the timer. A fourth set of computer instructions for, in response to an indication that the timer has expired, adjusting at least one supply voltage of the UFS device to sleep mode level to place the UFS device in sleep mode.

These and other features and advantages will become apparent from the following description, drawings and claims.

### BRIEF DESCRIPTION OF THE DRAWINGS

In the Figures, like reference numerals refer to like parts throughout the various views unless otherwise indicated.

FIG. 1 illustrates a transaction diagram demonstrating interactions between a UFS host and a UFS device over a UFS communications link and the manner in which an Auto Suspend process of the present disclosure is performed to place the UFS device in sleep or deep sleep mode in accordance with a representative, or exemplary, embodiment.

FIG. 2 illustrates a timing diagram that shows the relative timing of the events that occur during the Auto Suspend process described with reference to FIG. 1.

FIG. 3 illustrates a block diagram of a system in accordance with an exemplary embodiment for performing the Auto Suspend process described with reference to FIG. 1.

FIG. 4 is a table that shows a UFS Protocol Information Units (UPIU) command data structure as defined in the JEDEC 4.0 standard, except that it has been modified according to an exemplary embodiment of the present disclosure.

FIG. 5 is a table that shows the UPIU response data structure as defined in the JEDEC 4.0 standard, except that it has been modified according to an exemplary embodiment.

FIG. 6 shows the data structure of a background operations status identifier that is used to identify the criticality of background operations that may need to be performed before the UFS device enters sleep mode according to an exemplary embodiment.

FIG. 7 shows a table depicting how the UFS device shown in FIG. 3 generates the estimated Auto Suspend Timer value based on criticality of background operations to be performed according to an exemplary embodiment.

FIG. 8 illustrates a flow diagram of the Auto Suspend method in accordance with a representative embodiment of the present disclosure.

FIG. 9 illustrates an example of a personal computing device in which exemplary embodiments of systems, methods, computer-readable media, and other examples of the inventive principles and concepts of the present disclosure may be implemented.

### DETAILED DESCRIPTION

The present disclosure discloses systems and methods for enhancing UFS power mode transitions by autonomously entering the sleep or power down states upon the expiration of a timer, thereby eliminating the need to reactivate the link between the UFS host and the UFS device to send SSU sleep or power down commands from the UFS host to the UFS device. Eliminating the need to frequently reactivate the link to transition it into sleep and power down states reduces power consumption associated with reactivating the link and keeping it in the active state while the SSU sleep and power commands are transmitted by the UFS host and responded to by the UFS device. In addition, eliminating the need to frequently reactivate the link and keep it active for these purposes reduces latencies associated with issuing power mode commands.

In the following detailed description, for purposes of explanation and not limitation, exemplary, or representative, embodiments disclosing specific details are set forth in order to provide a thorough understanding of an embodiment according to the present teachings. The word “exemplary” is used herein to mean “serving as an example, instance, or illustration.” The words “illustrative” or “representative” may be used herein synonymously with “exemplary.” Any aspect described herein as “exemplary” is not necessarily to be construed as preferred or advantageous over other aspects. However, it will be apparent to one having ordinary skill in the art and having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device”includes one device and plural devices.

Relative terms may be used to describe the various elements'relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory device”, as that term is used herein, is intended to denote a non-transitory computer-readable storage medium that is capable of storing bits, such as bits that comprise computer instructions, or computer code, for execution by one or more processors. References herein to a “memory device” should be interpreted as including one or more memory devices.

A “processor”, as that term is used herein, encompasses an electronic component that is able to execute a computer program or executable computer instructions in software and/or firmware. References herein to a computer comprising “a processor” should be interpreted as one or more processors. The processor may for instance be a multi-core processor comprising multiple processing cores, each of which may comprise multiple processing stages of a processing pipeline. A processor may also refer to a collection of processors within a single system or distributed amongst multiple systems. The term “controller”is used herein interchangeably with the term “processor”.

The term “logic,” as that term is used herein, denotes digital circuits, such as digital gate structures, that are combined and configured in a particular manner to achieve one or more particular functions. For example, control logic can be a combination of digital circuits that have been combined and configured in a particular manner to achieve one or more particular control functions, either solely in hardware or in a combination of hardware, software and/or firmware.

A computing device may include multiple subsystems, cores or other components. Such a computing device may be, for example, a PCD, such as a laptop or palmtop computer, a cellular telephone or smartphone, a portable digital assistant, a portable game console, an automotive safety system, etc., or a non-portable computing device (NPCD) such as, for example, a PC, a desktop computer or a workstation computer.

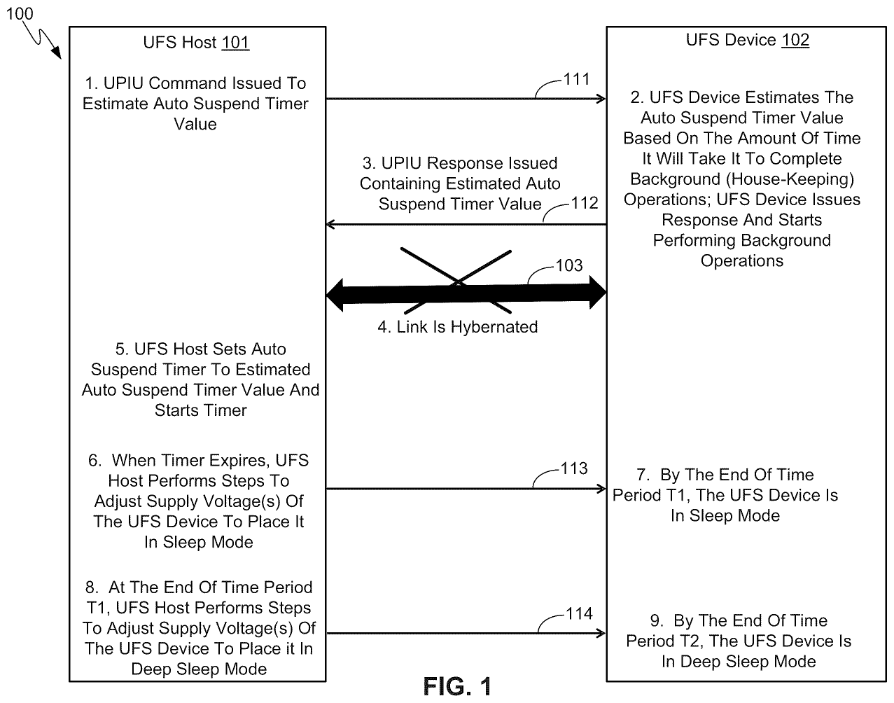

FIG. 1 illustrates a transaction diagram demonstrating interactions between a UFS host 101 and a UFS device 102 over a UFS communications link 103 and the manner in which an Auto Suspend process of the present disclosure is performed to place the UFS device 102 in sleep or deep sleep mode in accordance with a representative, or exemplary, embodiment. The Auto Suspend process reduces the aforementioned frequent reactivation of the link 103, thereby reducing power consumption and command issuance latencies. For demonstrative purposes, the transaction diagram assumes that the transactions are in accordance with the JEDEC UFS 4.0 standard, although the inventive principles and concepts are not limited to this standard. As will be understood by those of skill in the art in view of the description provided herein, standards are frequently updated or replaced, and therefore the inventive principles and concepts are not limited to any particular standard.

The system 100 comprises a UFS host 101, a UFS device 102 and the communication link 103 over which the UFS host 101 and the UFS device 102 interact with one another to transition the UFS device 102 in and out of various power modes, or states. In FIG. 1, the narrower arrows represent the transaction direction and the wider arrow 103 represents the actual link between the UFS host 101 and the UFS device 102. The actual link between a UFS device and a UFS host is established through a layered architecture that ensures efficient data transfer and communication. The layered architecture defined in the JEDEC UFS 4.0 standard comprises a host interface layer, a UFS interconnect (UIC) layer, a UFS command set (UCS) layer and a data management layer. For ease of illustration, the link is represented by arrow 103. In the interest of brevity, a detailed discussion of the layered architecture is not provided herein since it is known to those of skill in the art. In essence, the controller of the UFS host 101 and the UFS device 102 work together to provide a high-performance, low-power storage solution, primarily used in mobile devices and other applications requiring fast and reliable data storage In accordance with this embodiment, the UFS device 102 autonomously enters sleep mode and deep sleep mode (also referred to as power down mode) via the Auto Suspend process of the present disclosure. The Auto Suspend process of the present disclosure causes the sleep and deep sleep modes to be autonomously triggered, thereby obviating the need for the UFS host 101 to send and for the UFS device 102 to receive sleep and deep sleep commands to place the UFS device 102 in sleep and deep sleep modes, respectively.

In accordance with this representative embodiment, the UFS host 101 initiates an Auto Suspend action by packing a UFS Protocol Information Units (UPIU) Estimate Auto Suspend Time Value command into the last command contained in the command queue (CQ) of the UFS host 101 and sending the command over the link 103 to the UFS device 102. The “last command”, as that term is used herein, means the last command in time to be sent by the UFS host 101 to the UFS device 102 as part of the current transaction occurring between the UFS host 101 and the UFS device 102. This action is represented by the arrow labeled 111 in FIG. 1. The UPIU Estimate Auto Suspend Timer Value command is received by the UFS device 102. The UFS device 102 is configured to perform a process when it receives the UPIU Auto Suspend command that estimates the amount of time that it will take the UFS device 102 to perform certain background, or housekeeping, operations before it can be placed in the sleep mode. This estimate is sent in a UPIU response over the link 103 to the UFS host 101 as an estimated Auto Suspend Timer value, as indicated by arrow 112. Once the actions represented by arrows 111 and 112 have been taken, the link 103 is hibernated, i.e., deactivated, and thus is no longer consuming power or is consuming only a small amount of power.

When the UFS device 102 sends the estimated Auto Suspend Timer value to the UFS host 101, the UFS device 102 begins performing the background operations that need to be performed before the UFS device 102 can be placed in sleep mode. Simultaneously, or nearly simultaneously, the UFS host 101 receives the estimated value and sets an Auto Suspend Timer to the estimated Auto Suspend Timer value and then starts the timer. Arrow 113 represents this process. Placing the UFS device 102 in sleep mode requires the UFS host 101 to take certain steps needed to adjust one or more supply voltages of the of the UFS device 102 to appropriate levels for sleep mode. A first time period, T1, passes from the instant in time that the Timer expires to the instant in time that the UFS device 102 enters sleep mode. This time period T1 corresponds to the amount of time that it takes to perform these supply voltage adjustments represented by arrow 113. When the Auto Suspend Timer expires, it is reset to time period T1 and started. Alternatively, a separate timer can be used for this purpose. For exemplary purposes, it will be assumed that when the Auto Suspend Timer expires, it is reset to time period T1 and started.

Once the UFS device 102 is in sleep mode, i.e., at the end of time period T1, the Auto Suspend Timer or a separate timer is reset to a second time period, T2, and started. Time period T2 corresponds to the amount of time that is required for the UFS host 101 to perform the process of adjusting one or more supply voltages of the UFS device 102 to transition the UFS device 102 from sleep mode into deep sleep, or power down, mode. A third time period, T3, passes from the instant in time that the Timer expires for this first time to the instant in time that the UFS device 102 enters deep sleep mode, i.e., T3=T1+T2. Arrow 114 represents the UFS host 101 taking certain steps that are needed to adjust one or more supply voltages of the of the UFS device 102 to appropriate levels for deep sleep mode.

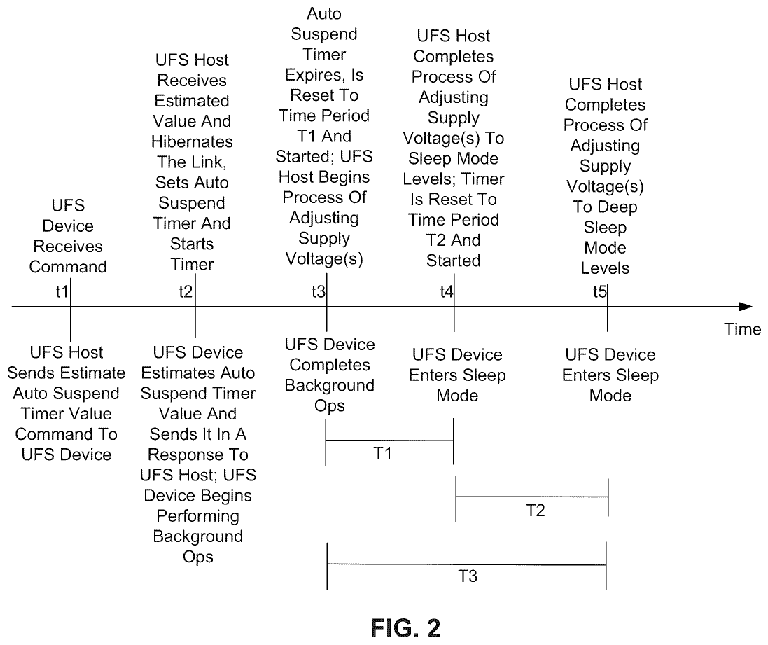

FIG. 2 illustrates a timing diagram that shows the relative timing of the events that occur during the Auto Suspend process described above with reference to FIG. 1. At time t1, the UFS host 101 initiates the Auto Suspend action by sending the Estimate Auto Suspend Timer Value command to the UFS device 102. Substantially simultaneously, the UPIU Estimate Auto Suspend Timer value command is received by the UFS device 102 and the UFS device 102 begins generating the estimate based on the background operations that need to be performed before it can enter sleep mode. At time t2, the UFS device 102 sends the estimated value to the UFS host 101 and begins performing the background operations that need to be performed before entering sleep mode. Substantially simultaneously, the UFS host 101 receives the estimated value, sets the timer, and starts the timer. The link 103 is hibernated after the UFS host 101 receives the estimated value.

At time t3, the timer expires, is reset to time period T1, started, and the UFS host 101 begins adjusting the supply voltage(s) of the UFS device 102 to sleep mode levels while the UFS device 102 completes the background operations. At time t4, the UFS host 101 completes the supply voltage adjustment(s) and the UFS device 102 enters sleep mode. Substantially simultaneously with the UFS device entering sleep mode, the Timer is reset to time period T2 and the UFS host 101 begins making supply voltage adjustment(s) needed to place the UFS device 102 in deep sleep mode. At time t5, the UFS host 101 completes the supply voltage adjustment(s) and the UFS device 102 enters deep sleep mode.

As can be seen in FIG. 2, the first time period T1 passes from the instant in time that the Timer expires the first time to the instant in time that the UFS device 102 enters sleep mode. As indicated above, this time period T1 corresponds to the amount of time that it takes to perform these supply voltage adjustment(s) needed to place the UFS device 102 in sleep mode. The second time period T2 passes from the instant in time t4 when the UFS device 102 enters sleep mode to the instant in time that the UFS device 102 enters deep sleep mode. T3 corresponds to the amount of time that passes from time instant t3 to the instant in time that the UFS device 102 enters deep sleep mode (T3=T1+T2). Time period T1 can be, for example, 10 milliseconds (ms) and time T2 can be, for example, 20 ms.

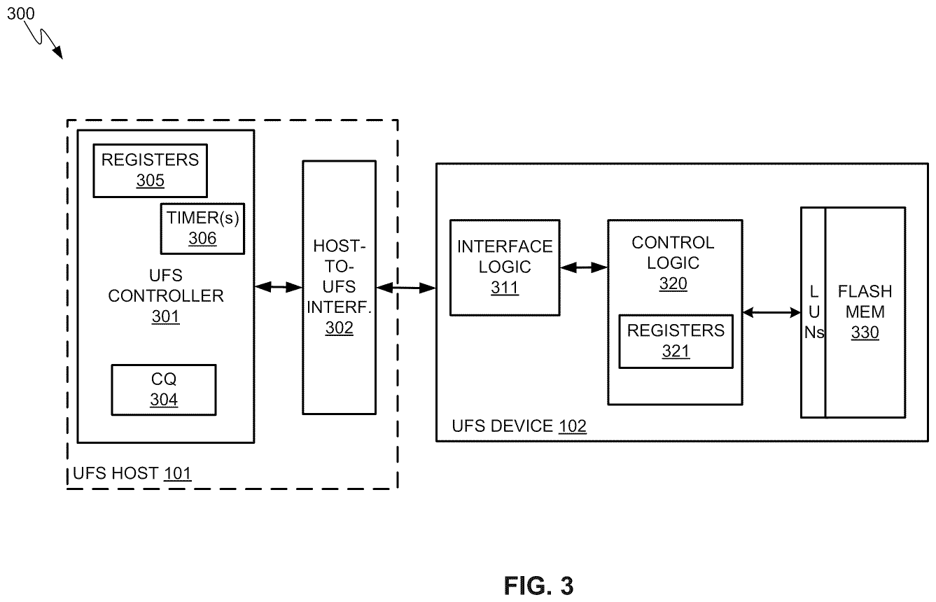

FIG. 3 illustrates a block diagram of a system 300 in accordance with an exemplary embodiment for performing the process described above with reference to FIG. 1. A UFS controller 301 of the UFS host 101 is configured to control the operations of the UFS host 101 to cause it to communicate with the UFS device 102 via a host-to-UFS device interface 302 to perform transactions of the type described above with reference to FIG. 1. The host controller 301 comprises processing logic that is configured to perform the processes described above with reference to FIG. 1 as well as processing logic that is configured to perform additional processes that are outside of the scope of this disclosure and therefore are not discussed herein in the interest of brevity. Likewise, the UFS device 102 comprises logic that is configured to perform the processes described above with reference to FIG. 1 as well as logic that is configured to perform additional processes that are not discussed herein in the interest of brevity.

A command queue (CQ) 304 of the UFS controller 301 holds UPIU commands to be sent to the UFS device 102, including the Estimate Auto Suspend Timer Value command discussed above with reference to FIG. 1. The host controller 301 also comprises one or more registers 305 for holding bit values and one or more timers 306 for performing the timing operations discussed above with reference to FIGS. 1 and 2. The register(s) 305 can be any suitable memory of the host controller 301.

Interface logic 311 of the UFS device 102 is configured to interface with the host-to-UFS device interface 302 and to interface with control logic 320 of the UFS device 102. The control logic 320 is configured to perform the processes described above with reference to FIG. 1 as well as additional tasks that are beyond the scope of this disclosure and are not discussed herein in the interest of brevity. The control logic 320 also comprises one or more registers 321 for holding bit values. The register(s) 321 can be any suitable memory of the control logic 320. Flash memory 330 of the UFS device 102 contains physical blocks of flash memory cells that are addressed based on instructions from the control logic 320 to perform write, read, erase and purge operations.

As will be described in more detail below, the UFS host 101 can be a component of an SoC, which can be implemented in a PCD, such as a mobile phone, for example. It should be noted, however, that the inventive principles and concepts are not limited to being part of or implemented in any particular device or used for any particular application, as will be understood by those of skill in the art in view of the description provided herein.

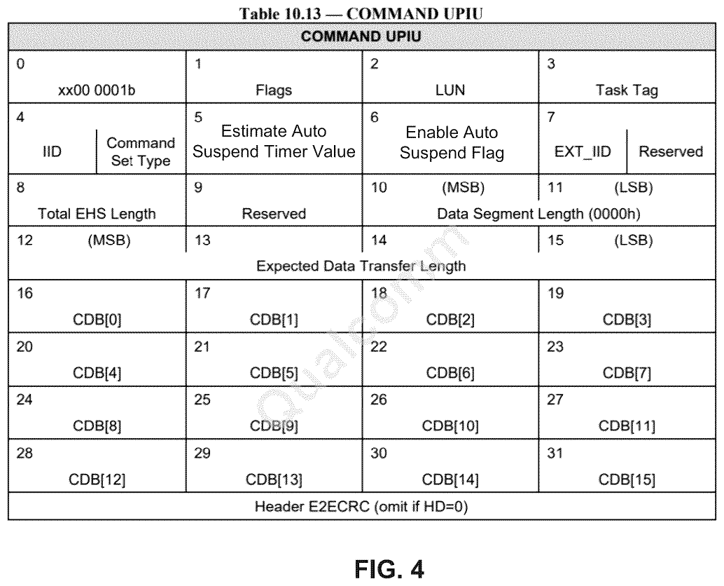

In accordance with a representative embodiment, one of the reserved bits of the UPIU command data structure is used to instruct the UFS device 102 to estimate the Auto Suspend Timer value discussed above with reference to FIG. 1. FIG. 4 is a table that shows the UPIU command data structure as defined in the JEDEC 4.0 standard, except that it has been modified to indicate that bits 5 and 6, which are currently reserved in the standard, are used to, respectively, instruct the UFS device 102 to respond with the estimated Auto Suspend Timer value and enable an Auto Suspend flag of the UFS device 102 to cause it to flush all logical block units of the flash memory cells 330 (FIG. 3) to system memory (not shown). When the link 103 is in the HIBERN8 state and there is no activity over the link 103, the JEDEC UFS 4.0 standard dictates that the data stored in the single-level-cell (SLC) flash memory cells of the write booster buffer (not shown) of the UFS device be flushed to the triple-level-cell (TLC) flash memory cells of the main medium of the UFS device. The bit 6 flag is used for this purpose.

It should be noted that using bit 5 of the command UPIU data structure is merely an example of one way of communicating the Auto Suspend instruction to the UFS device 102 and initiating the Auto Suspend process. As will be understood by those of skill in the art in view of the description provided herein, the Auto Suspend instruction can be communicated to the UFS device 102 in a variety of ways and the inventive principles and concepts are not limited to the manner in which this task is performed.

In accordance with a preferred embodiment, the UFS host 101 identifies the last command in the CQ 304, packs bits 5 and 6 into the command and sends the command over the link 103 to the UFS device. The control logic 320 of the UFS device 102 determines, based on bit 5 being asserted, that it is being instructed to estimate the Auto Suspend Timer value based on background operations it has to complete before it can be placed in sleep mode and responds to the UFS host with a UPIU response that contains the estimated value. Based on bit 6 being asserted, the control logic 320 of the UFS device 102 flushes the data stored in the write booster buffer of the flash memory 330 to the main medium of the flash memory 330. The Auto Suspend process then proceeds in the manner described above with reference to FIG. 1 to hibernate the link 103 and place the UFS device 102 in sleep mode and deep sleep mode.

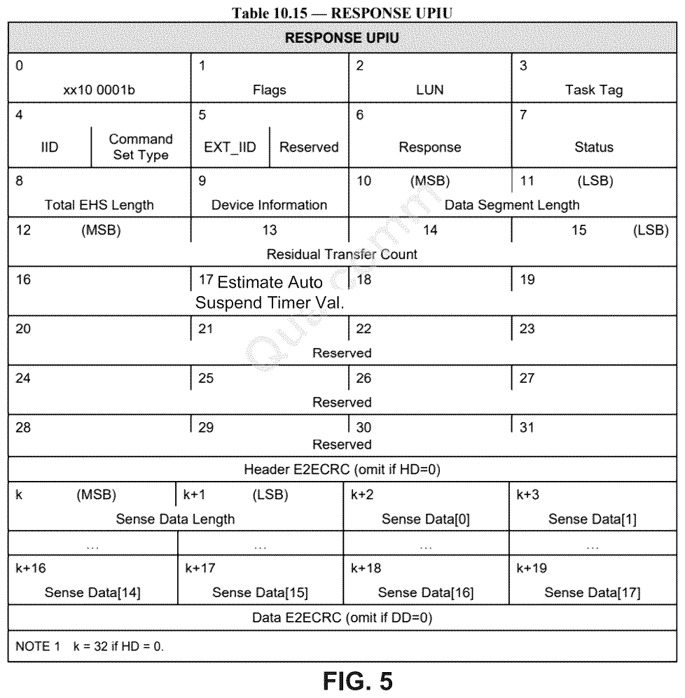

FIG. 5 is a table that shows the UPIU response data structure as defined in the JEDEC 4.0 standard, except that bit field 17, which is currently reserved in the JEDEC 4.0 standard, has been allocated to contain a bit value representing the estimated Auto Suspend Timer value. When this response, represented by arrow 112 in FIG. 1, is received by the UFS host 101, the host sets the Auto Suspend Timer, starts the Timer and when the Timer expires, performs the processes of adjusting the supply voltage values represented by arrows 113 and 114 and described above with reference to FIG. 1.

It should be noted that using bit field 17 of the response UPIU data structure for this purpose is merely an example of one way of communicating the estimated Auto Suspend Timer value to the UFS host 101. As will be understood by those of skill in the art in view of the description provided herein, the estimated Auto Suspend Timer value can be communicated to the UFS host 101 in a variety of ways and the inventive principles and concepts are not limited to the manner in which this task is performed.

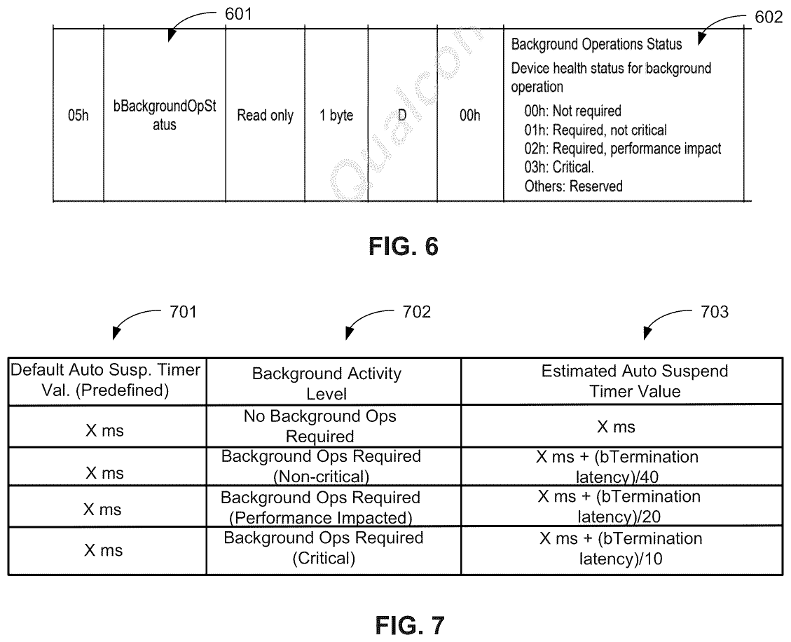

FIG. 6 shows the data structure of a background operations status identifier in accordance with a representative embodiment of the present disclosure that includes bit fields that identify the criticality of background operations that need to be performed by the UFS device 102 before the UFS device 102 enters sleep mode. The bits comprising the background operations status identifier can be held in one or more of the registers 321 of the UFS device 102. If the bBackgroundOpStatus bit 601 in the data structure shown in FIG. 6 is set to logic 0 in register 321, this indicates that there is no immediate need to execute background operations. When bit 601 is set to logic 1, this indicates that there is an immediate need to execute background operations.

Bit field 602 is used to identify the criticality of background operations. The manner in which the UFS device 102 calculates the estimated Auto Suspend Timer value depends on the value of bit field 602. In particular:
00h: No operations required;
01h: Operations outstanding (non-critical);
02h: Operations outstanding (performance being impacted);
03h: Operations outstanding (critical).
   An exemplary embodiment of the manner in which the value of bit field 602 is used to calculate the estimated Auto Suspend Timer value is shown in the table of FIG. 7.

FIG. 7 shows a table depicting an exemplary embodiment of how the UFS device 102 generates the estimated Auto Suspend Timer value based on the criticality of background operations to be performed according to the values of bit 601 and bit word 602. Column 701 corresponds to a default value of X milliseconds (ms) for the estimated Auto Suspend Timer value that preferably is set by the manufacturer, where X is a positive number equal to the default estimated Auto Suspend Timer value. Column 702 corresponds to the level of criticality of the background operations identified by the value represented by the bit field 602. Column 703 shows examples of mathematical equations that can be used to calculate the estimated Auto Suspend Timer value based on the corresponding level of criticality.

As shown in the table of FIG. 7, if no background operations are required, the estimated Auto Suspend Timer value is equal to the default value of X ms, which in most cases will be zero. If non-critical background operations need to be performed, the estimated Auto Suspend Timer value can be set equal to the sum of the default value of X ms and bTermination latency/40, where bTermination latency is the maximum amount of time that it takes the UFS device 102 to perform background operations. If the background operations that need to be performed can impact performance, the estimated Auto Suspend Timer value can be set equal to the sum of the default value of X ms and bTermination latency/20. If critical background operations need to be performed, the estimated Auto Suspend Timer value can be set equal to the sum of the default value of X ms and bTermination latency/10. The denominator values of 40, 20 and 10 in the table can be configurable parameters S, T and V, respectively, having positive values where T is less than S and V is less than T. The default value of X will typically be set by the original equipment manufacturer (OEM).

It should be noted that the inventive principles and concepts are not limited with respect to the manner in which the estimated Auto Suspend Timer value is computed or determined, as will be understood by those of skill in the art in view of the description provided herein. The table shown in FIG. 7 is only one example of the manner in which the estimated Auto Suspend Timer value can be computed or determined. As another example, a lookup table (LUT) could be used for this purpose where the bit fields 602 is used to address the LUT.

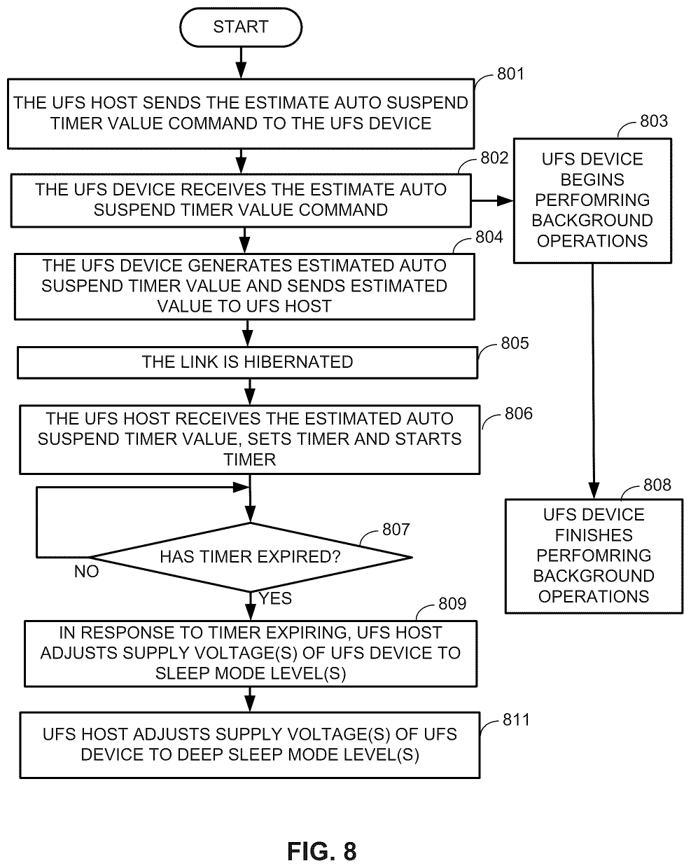

FIG. 8 illustrates a flow diagram of the Auto Suspend method in accordance with a representative embodiment of the present disclosure. Block 801 represents the step of the UFS host 101 initiating the Auto Suspend action by sending the Estimate Auto Suspend Timer Value command to the UFS device 102. Block 802 represents the step of the Estimate Auto Suspend Timer value command being received by the UFS device 102 and block 803 represents the step of the UFS device 102 beginning the process of performing the background operations.

Block 804 represents the step of the UFS device generating the estimate based on the need to perform before it can enter sleep mode and sending the estimated value to the UFS host 101. Block 805 represents the step of the UFS host hibernating the link. Block 806 represents the UFS host 101 receiving the estimated value, setting the Auto Suspend Timer to the estimated value and starting the timer. Block 807 corresponds to the UFS host 101 determining when the Timer expires. When the Timer expires, the UFS host 101 begins adjusting the supply voltage(s) of the UFS device 102 to sleep mode levels and the UFS device 102 completes the background operations. The background operations are completed by the instant in time that the Timer expires, as indicated by block 808.

By the end of time period T1 (FIG. 2), the UFS host 101 has completed the supply voltage adjustment(s) and the UFS device 102 enters sleep mode, as indicated by block 809. By the end of time T2, the UFS host 101 has completed the deep sleep mode supply voltage adjustment(s) and the UFS device 102 enters deep sleep mode, as indicated by block 811.

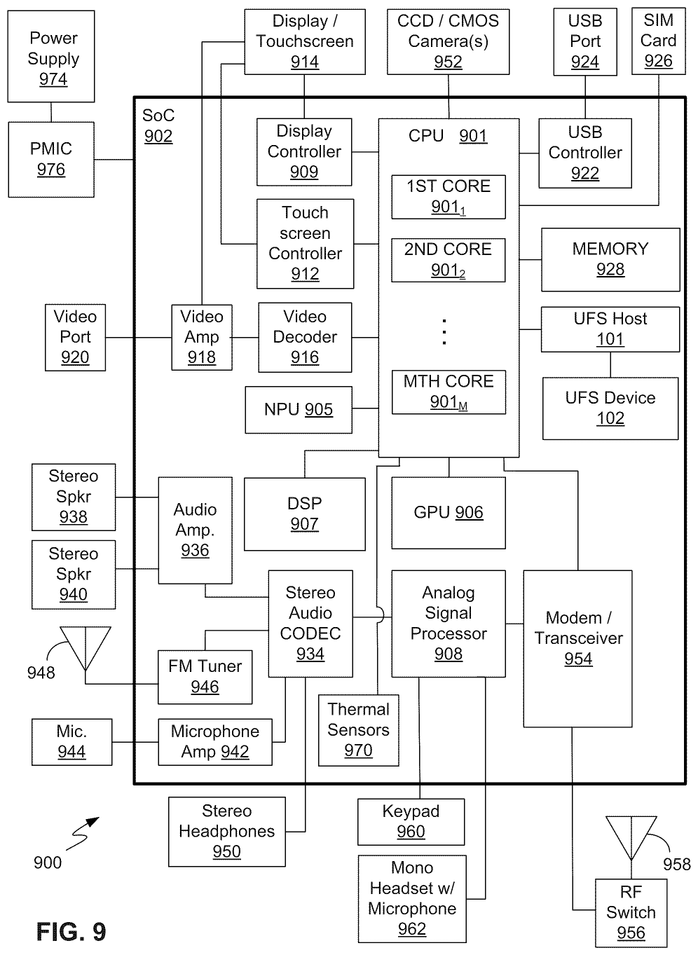

FIG. 9 illustrates an example of a PCD 900, such as a mobile phone, a smartphone, a portable game console such as an Extended Reality (XR) device, a Virtual Reality (VR) device, an Augmented Reality (AR) device, or a Mixed Reality (MR) device, etc., in which exemplary embodiments of systems, methods, computer-readable media, and other examples of the inventive principles and concepts of the present disclosure may be implemented. The PCD 900 comprises an SoC 902, which comprises the system 300 shown in FIG. 3 or a similar system configured to perform the methods described above with reference to FIGS. 1-8 . For purposes of clarity, some interconnects, signals, etc., are not shown in FIG. 5. The UFS device 102 is shown in FIG. 9 as being internal to the SoC 902 for ease of illustration, but it could be external to the SoC 902.

The SoC 902 may include a CPU 901, an NPU 905, a GPU 906, a DSP 907, an analog signal processor 908, a modem/modem subsystem 954, and/or other processors. Any processor of the SoC 902 can operate as the UFS host 101 shown in FIG. 3. The CPU 901 may include one or more CPU cores, such as a first CPU core 901₁, a second CPU core 901₂, etc., through an M^{th} CPU core 901_{M}. A display controller 909 and a touch-screen controller 912 may be coupled to the CPU 901. A touchscreen display 914 external to the SoC 902 may be coupled to the display controller 909 and the touch-screen controller 912. The PCD 900 may further include a video decoder 916 coupled to the CPU 901. A video amplifier 918 may be coupled to the video decoder 916 and the touchscreen display 914. A video port 920 may be coupled to the video amplifier 918. A universal serial bus (“USB”) controller 922 may also be coupled to CPU 901, and a USB port 924 may be coupled to the USB controller 922. A subscriber identity module (“SIM”) card 926 may also be coupled to the CPU 901.

One or more memories 928 may be coupled to the CPU 901. The one or more memories 928 may include both volatile and non-volatile memories. Examples of volatile memories include static random access memory (“SRAM”), dynamic random access memory (“DRAM”), double data rate synchronous DRAM (DDR SDRAM), etc. Such memories may be external to the SoC 902 or internal to the SoC 902. The one or more memories 928 may also include local cache memory or a system-level cache memory.

A stereo audio CODEC 934 may be coupled to the analog signal processor 908. An audio amplifier 936 may be coupled to the stereo audio CODEC 934. First and second stereo speakers 938 and 940, respectively, may be coupled to the audio amplifier 936. In addition, a microphone amplifier 942 may be coupled to the stereo audio CODEC 934, and a microphone 944 may be coupled to the microphone amplifier 942. A frequency modulation (“FM”) radio tuner 946 may be coupled to the stereo audio CODEC 934. An FM antenna 948 may be coupled to the FM radio tuner 946. Further, stereo headphones 950 may be coupled to the stereo audio CODEC 934. Other devices that may be coupled to the CPU 901 include one or more digital (e.g., CCD or CMOS) cameras 952.

A modem or RF transceiver 954 may be coupled to the analog signal processor 908 and the CPU 901. An RF switch 956 may be coupled to the RF transceiver 954 and an RF antenna 958. A keypad 960 and a mono headset with a microphone 962 may be coupled to the analog signal processor 908. The SoC 902 may have one or more internal or on-chip thermal sensors 970. A power supply 974 and a power management IC (PMIC) 976 may supply power to the SoC 902.

Firmware or software may be stored in any of the above-described memories, or may be stored in a local memory directly accessible by the processor hardware on which the software or firmware executes. Execution of such firmware or software by logic of the UFS device 102, by the UFS host 101 and by the CPU 901 may control aspects of any of the above-described methods or configure aspects of any of the above-described systems. Any such memory or other non-transitory storage medium having firmware or software stored therein in computer-readable form for execution by processor hardware may be an example of a “computer-readable medium,” as the term is understood in the patent lexicon.

Implementation examples are described in the following numbered clauses:
1. A method for performing power transitions in a Universal Flash Storage (UFS) system comprising a UFS host and a UFS device, the method comprising:
   with the UFS host, sending a command to the UFS device over a link that instructs the UFS device to generate a time value estimate;
   in the UFS device, in response to receiving the command:
      generating the time value estimate; and
      sending the time value estimate over the link in a response to the UFS host;
   in the UFS host, in response to receiving the time value estimate in the UFS host:
      causing the link to be hibernated;
      setting a timer to the time value estimate and starting the timer; and
      in response to an indication that the timer has expired, adjusting at least one supply voltage of the UFS device to a sleep mode level.
2. The method of clause 1, further comprising:
   with the UFS host, after the UFS device has been placed in sleep mode, adjusting at least one supply voltage of the UFS device to a deep sleep mode level.
3. The method of any of clauses 1-2, wherein the time value estimate corresponds to an amount of time required for the UFS device to perform any background operations that need to be performed by the UFS device before the UFS device can be placed in sleep mode.
4. The method of clause 3, wherein if no background operations need to be performed by the UFS device before the UFS device is placed in sleep mode, the time value estimate is generated by the UFS device based on a default time value.
5. The method of claim 3, wherein the step of generating the time value estimate includes:
   determining a level of criticality of any background operations that need to be performed by the UFS device before the UFS device is placed in sleep mode; and calculating the time value estimate based on the determined level of criticality.
6. The method of claim 5, wherein the step of calculating the time value estimate comprises:
   calculating the time value estimate as X milliseconds (ms)+bTerminationlatency/S in response to a determination that the level of criticality is non-critical, where X is a positive default value, S is a positive value and bTerminationlatency is a maximum amount of time required for the UFS device to perform background operations;
   calculating the time value estimate as X ms+bTerminationlatency/T in response to a determination that the level of criticality is performance-impacting, where T is a positive value that is less than S;
   calculating the time value estimate as X ms+bTerminationlatency/V in response to a determination that the level of criticality is critical, where V is a positive value that is less than T; and
   calculating the time value estimate to be equal to X ms in response to a determination that the level of criticality is that no background operations need to be performed.
7. The method of any of clauses 1-6, wherein the response that is sent from the UFS device to the UFS host comprises a UFS Protocol Information Units (UPIU) response having a data structure as defined by a Joint Electron Device Engineering Council (JEDEC) Universal Flash Storage (UFS) standard, the data structure including one or more bits representing the time value estimate.
8. The method of any of clauses 1-7, wherein the command is a UFS Protocol Information Units (UPIU) command having a data structure as defined by a Joint Electron Device Engineering Council (JEDEC) Universal Flash Storage (UFS) standard except that the data structure is modified to include one or more bits comprising an instruction that instructs the UFS device to generate the time value estimate.
9. A system for performing power transitions in a Universal Flash Storage (UFS) system comprising:
   a UFS host comprising a UFS controller comprising:
      logic configured to send a command to a UFS device over a link that instructs the UFS device to generate a time value estimate;
      logic configured to receive the time value estimate in a response from the UFS device over the link;
      logic configured to, in response to receiving the time value estimate in the host device, cause the link to be hibernated, set a timer to the time estimate value and start the timer; and
      logic configured to, in response to an indication that the timer has expired, adjust at least one supply voltage of the UFS device to sleep mode level to place the UFS device in sleep mode.
10. The system of clause 9, further comprising:
   the UFS device, the UFS device comprising:
      logic configured to generate the time value estimate in response to receiving the command from the UFS host; and
      logic configured to send the time value estimate in a response to the UFS host.
11. The system of clause 10, wherein the UFS controller further comprises:
   logic configured to adjust at least one supply voltage of the UFS device to a deep sleep mode level after the UFS device has been placed in sleep mode.
12. The system of any of clauses 9-10, wherein the time value estimate corresponds to an amount of time required for the UFS device to perform any background operations that need to be performed by the UFS device before the UFS device can be placed in sleep mode.
13. The system of clause 12, wherein if no background operations need to be performed by the UFS device before the UFS device is placed in sleep mode, the time value estimate is generated by the UFS device based on a default time value.
14. The system of claim 12, wherein the logic configured to generate the time value estimate comprises:
   logic configured to determine a level of criticality of any background operations that need to be performed by the UFS device before the UFS device is placed in sleep mode; and
   logic configured to calculate the time value estimate based on the determined level of criticality.
15. The system of claim 14, wherein the logic configured to calculate the time value estimate comprises:
   logic configured to calculate the time value estimate as:
      X milliseconds (ms)+bTerminationlatency/S in response to a determination that the level of criticality is non-critical, where X is a positive default value, S is a positive value and bTerminationlatency is a maximum amount of time required for the UFS device to perform background operations;
      X ms+bTerminationlatency/T in response to a determination that the level of criticality is performance-impacting, where T is a positive value that is less than S;
      X ms+bTerminationlatency/V in response to a determination that the level of criticality is critical, where V is a positive value that is less than T; and
      equal to X ms in response to a determination that the level of criticality is that no background operations need to be performed.
16. The system of any of clauses 9-15, wherein the response that is sent from the UFS device to the UFS host comprises a UFS Protocol Information Units (UPIU) response having a data structure as defined by a Joint Electron Device Engineering Council (JEDEC) Universal Flash Storage (UFS) standard, the data structure including one or more bits representing the time value estimate.
17. The system of any of clauses 10-16, wherein the command is a UFS Protocol Information Units (UPIU) command having a data structure as defined by a Joint Electron Device Engineering Council (JEDEC) Universal Flash Storage (UFS) standard except that the data structure is modified to include one or more bits comprising an instruction that instructs the UFS device to generate the time value estimate.
18. A computer program for performing power transitions in a Universal Flash Storage (UFS) system comprising a UFS host and a UFS device, the computer program comprising computer instructions for processing by a processor, the computer instructions being embodied on a non-transitory computer-readable medium, the computer instructions comprising:
   a first set of computer instructions for sending a command from the UFS host to the UFS device over a link that instructs the UFS device to generate a time value estimate;
   a second set of computer instructions for receiving the time value estimate from the UFS device over the link;
   a third set of computer instructions for, in response to receiving the time value estimate in the host device, causing the link to be hibernated, setting a timer to the time estimate value and starting the timer; and
   a fourth set of computer instructions for, in response to an indication that the timer has expired, adjusting at least one supply voltage of the UFS device to sleep mode level to place the UFS device in sleep mode.
19. The computer program of clause 18, wherein the time value estimate corresponds to an amount of time required for the UFS device to perform one or more background operations that need to be performed by the UFS device before the UFS device can be placed in sleep mode.
20. The computer program of any of clauses 18-19v, further comprising:
   a fifth set of computer instructions for adjusting at least one supply voltage of the UFS device to a deep sleep mode level after the UFS device has been placed in sleep mode.

Alternative embodiments will become apparent to one of ordinary skill in the art to which the invention pertains in view of the present disclosure. Therefore, although selected aspects have been illustrated and described in detail, it will be understood that various substitutions and alterations may be made therein.

What is claimed is:

1. A method for performing power transitions in a Universal Flash Storage (UFS) system comprising a UFS host and a UFS device, the method comprising:
with the UFS host, sending a command to the UFS device over a link that instructs the UFS device to generate a time value estimate;
in the UFS device, in response to receiving the command:
generating the time value estimate; and
sending the time value estimate over the link in a response to the UFS host;
in the UFS host, in response to receiving the time value estimate in the UFS host:
causing the link to be hibernated;
setting a timer to the time value estimate and starting the timer; and
in response to an indication that the timer has expired, adjusting at least one supply voltage of the UFS device to a sleep mode level.

2. The method of claim 1, further comprising:
with the UFS host, after the UFS device has been placed in sleep mode, adjusting at least one supply voltage of the UFS device to a deep sleep mode level.

3. The method of claim 1, wherein the time value estimate corresponds to an amount of time required for the UFS device to perform any background operations that need to be performed by the UFS device before the UFS device can be placed in sleep mode.

4. The method of claim 3, wherein if no background operations need to be performed by the UFS device before the UFS device is placed in sleep mode, the time value estimate is generated by the UFS device based on a default time value.

5. The method of claim 3, wherein the step of generating the time value estimate includes:
determining a level of criticality of any background operations that need to be performed by the UFS device before the UFS device is placed in sleep mode; and
calculating the time value estimate based on the determined level of criticality.

6. The method of claim 5, wherein the step of calculating the time value estimate comprises:
calculating the time value estimate as X milliseconds (ms)+bTerminationlatency/S in response to a determination that the level of criticality is non-critical, where X is a positive default value, S is a positive value and bTerminationlatency is a maximum amount of time required for the UFS device to perform background operations;
calculating the time value estimate as X ms+bTerminationlatency/T in response to a determination that the level of criticality is performance-impacting, where T is a positive value that is less than S;
calculating the time value estimate as X ms+bTerminationlatency/V in response to a determination that the level of criticality is critical, where V is a positive value that is less than T; and
calculating the time value estimate to be equal to X ms in response to a determination that the level of criticality is that no background operations need to be performed.

7. The method of claim 1, wherein the response that is sent from the UFS device to the UFS host comprises a UFS Protocol Information Units (UPIU) response having a data structure as defined by a Joint Electron Device Engineering Council (JEDEC) Universal Flash Storage (UFS) standard, the data structure including one or more bits representing the time value estimate.

8. The method of claim 1, wherein the command is a UFS Protocol Information Units (UPIU) command having a data structure as defined by a Joint Electron Device Engineering Council (JEDEC) Universal Flash Storage (UFS) standard except that the data structure is modified to include one or more bits comprising an instruction that instructs the UFS device to generate the time value estimate.

9. A system for performing power transitions in a Universal Flash Storage (UFS) system comprising:
a UFS host comprising a UFS controller comprising:
logic configured to send a command to a UFS device over a link that instructs the UFS device to generate a time value estimate;
logic configured to receive the time value estimate from the UFS device over the link;
logic configured to, in response to receiving the time value estimate in the host device, cause the link to be hibernated, set a timer to the time estimate value and start the timer; and
logic configured to, in response to an indication that the timer has expired, adjust at least one supply voltage of the UFS device to sleep mode level to place the UFS device in sleep mode.

10. The system of claim 9, further comprising:
the UFS device, the UFS device comprising:
logic configured to generate the time value estimate in response to receiving the command from the UFS host; and
logic configured to send the time value estimate in a response to the UFS host.

11. The system of claim 10, wherein the UFS controller further comprises:
logic configured to adjust at least one supply voltage of the UFS device to a deep sleep mode level after the UFS device has been placed in sleep mode.

12. The system of claim 10, wherein the time value estimate corresponds to an amount of time required for the UFS device to perform any background operations that need to be performed by the UFS device before the UFS device can be placed in sleep mode.

13. The system of claim 12, wherein if no background operations need to be performed by the UFS device before the UFS device is placed in sleep mode, the time value estimate is generated by the UFS device based on a default time value.

14. The system of claim 12, wherein the logic configured to generate the time value estimate comprises:
logic configured to determine a level of criticality of any background operations that need to be performed by the UFS device before the UFS device is placed in sleep mode; and
logic configured to calculate the time value estimate based on the determined level of criticality.

15. The system of claim 14, wherein the logic configured to calculate the time value estimate comprises:
logic configured to calculate the time value estimate as:
X milliseconds (ms)+bTerminationlatency/S in response to a determination that the level of criticality is non-critical, where X is a positive default value, S is a positive value and bTerminationlatency is a maximum amount of time required for the UFS device to perform background operations;
X ms+bTerminationlatency/T in response to a determination that the level of criticality is performance-impacting, where T is a positive value that is less than S;
X ms+bTerminationlatency/V in response to a determination that the level of criticality is critical, where V is a positive value that is less than T; and
equal to X ms in response to a determination that the level of criticality is that no background operations need to be performed.

16. The system of claim 10, wherein the response that is sent from the UFS device to the UFS host comprises a UFS Protocol Information Units (UPIU) response having a data structure as defined by a Joint Electron Device Engineering Council (JEDEC) Universal Flash Storage (UFS) standard, the data structure including one or more bits representing the time value estimate.

17. The system of claim 10, wherein the command is a UFS Protocol Information Units (UPIU) command having a data structure as defined by a Joint Electron Device Engineering Council (JEDEC) Universal Flash Storage (UFS) standard except that the data structure is modified to include one or more bits comprising an instruction that instructs the UFS device to generate the time value estimate.

18. A computer program for performing power transitions in a Universal Flash Storage (UFS) system comprising a UFS host and a UFS device, the computer program comprising computer instructions for processing by a processor, the computer instructions being embodied on a non-transitory computer-readable medium, the computer instructions comprising:
a first set of computer instructions for causing a command to be sent from the UFS host to the UFS device over a link that instructs the UFS device to generate a time value estimate;
a second set of computer instructions for receiving the time value estimate from the UFS device over the link;
a third set of computer instructions for, in response to receiving the time value estimate in the host device, causing the link to be hibernated, setting a timer to the time estimate value and starting the timer; and
a fourth set of computer instructions for, in response to an indication that the timer has expired, adjusting at least one supply voltage of the UFS device to sleep mode level to place the UFS device in sleep mode.

19. The computer program of claim 18, wherein the time value estimate corresponds to an amount of time required for the UFS device to perform one or more background operations that need to be performed by the UFS device before the UFS device can be placed in sleep mode.

20. The computer program of claim 18, further comprising:
a fifth set of computer instructions for adjusting at least one supply voltage of the UFS device to a deep sleep mode level after the UFS device has been placed in sleep mode.
